(19) United States
(12) Patent Application Publication
(10) Pub. No.: US 2026/0166908 A1
(43) Pub. Date: Jun. 18, 2026

(54) OPTICAL VARIABLE ELEMENT BASED ON DIFFRACTIVE MOIRE PATTERNS

(71) Applicant: THALES DIS FRANCE SAS, Meudon (FR)

(72) Inventors: Laurent DAVOINE, Rosenau (FR); Thomas NEUENSCHWANDER, Nidergösgen (CH)

(73) Assignee: THALES DIS FRANCE SAS, Meudon (FR)

(21) Appl. No.: 19/129,354

(22) PCT Filed: Nov. 20, 2023
(86) PCT No.: PCT/EP2023/082367

§ 371 Date: May 13, 2025

(30) Foreign Application Priority Data
Nov. 30, 2022 (EP) 22306763.8

(51) Int. Cl. B42D 25/328; B42D 25/342; B42D 25/351

(52) U.S. Cl. CPC B42D 25/328; B42D 25/342; B42D 25/351

(57) ABSTRACT

Provided is a personalized medium that includes a core layer having at least a clear window or transparent portion, at least a first diffraction grating on an upper surface or a lower surface of the core layer, and a second diffraction grating on an opposing side of the core layer from the first diffraction grating, wherein the first and second diffraction gratings create a Moire pattern. The diffraction gratings have at least one of slightly different periods, shifted horizontal and vertical positioning, or shifted rotation positioning to create the Moire pattern, for example, wherein the first diffraction grating, the opaque core layer and the second diffraction grating are laminated together to form the personalized medium. The Moire pattern can shift rapidly upon tilting or movement and provides a strong color variation combined with dark or bright fringe pattern movement. Other embodiments disclosed.

### CROSS-REFERENCE TO RELATED APPLICATIONS

Not applicable.

### TECHNICAL FIELD

The present disclosure generally relates to anti-counterfeiting and authentication methods and devices. More particularly, but not exclusively, the present disclosure relates to use of optical variable elements using Moire patterns for security measures for authentication and anti-counterfeiting.

### BACKGROUND

Many forms of physical media require both mass-production and end-user personalization. For example, identity cards may need to be produced for very large population pools, yet every individual card has to uniquely identify the person carrying the card. The high-volume manufacturing phase may be performed on relatively expensive equipment because the equipment cost may be amortized over very large production runs. On the other hand, the end-user personalization may be preferably carried out at customer locations in relatively low volumes, thus, requiring much lower equipment costs.

For many identity cards, security of all information on the card, whether digitally recorded or physical features of the card, is of paramount importance. The security is sometimes tied to some features that reveal whether the media has physically been tampered with. One mechanism for thwarting attempts to tamper with identity cards is lamination. By securing the physical media in a lamination layer that may not be delaminated without destroying the physical pristineness of the media goes very far to protect the security integrity of media. One very important mechanism for tying an individual to an identity object is the placement of a person's photograph on the identity object. Driver's licenses, passports, identity cards, employee badges, etc., all usually bear the image of the individual to whom the object is connected. Laser engraving provides one prior art technique for personalizing an identity card post-issuance with a photograph. FIG. 1 is a perspective-exploded view of the various layers that make up such a prior art identity card 50. The identity card 50 may include a laser-engravable transparent polycarbonate layer 57. By selectively exposing an image area on the card with a laser, specific locations in the polycarbonate layer 57 may be rendered black, thereby producing a gray-scale image.

Traditionally polycarbonate (PC) ID products have been personalized using laser-engraving technology. This is based on a laser beam heating carbon particles inside specific polycarbonate layers to the extent that the polycarbonate around the particle turns black. While the particles could be chosen to be something else than carbon, it is the intrinsic property of polycarbonate that creates the desired contrast and number of gray levels to produce, for example, a photograph. The gray tone is controlled by the laser power and speed of scanning across the document. This technology is standard on the ID market. However, a limitation of this technique is that color images may not be produced in that manner.

In certain markets and applications it is desirable to have identity cards with color images. Traditionally color photographs have been placed in identity cards using Dye Diffusion Thermal Transfer (D2T2) technology, which has been available for PVC and PET products. Recently the development in the D2T2 technology has made it possible to color-personalize also polycarbonate cards. This technology requires a smooth printed surface and the printed image must be shielded with an overlay film, which can also be holographic type. A drawback to surface printed color personalization is that it is not as secure as the laser engraved photos and data that are situated inside the polycarbonate layer structure as illustrated in FIG. 1.

In another prior art alternative, a color image may be produced using digital printing before the product is collated. This allows for high quality images placed on identity cards. Yet this technology has many drawbacks: the personalization and card body manufacturing must happen in the same premises, which furthermore typically have to be in the country of document issuance because governmental authorities dislike sending civil register data across borders, the color printed photographs prevent the PC layers from fusing to each other, and if any of the cards on a sheet is maculated in further production steps, the personalized card must be reproduced from the beginning of the process leading to a highly complicated manufacturing process.

U.S. Pat. No. 7,368,217 to Lutz et al., Multilayer Image, Particularly a Multicolor Image, May 6, 2008 describes a technique in which color pigments are printed on collated sheets and each color may be bleached to a desired tone using a color sensitive laser.

In order to further secure such documents, it is known to produce one image on the document as described above and to reproduce somewhere else on the document a printed coded area which represents the same image but in a coded way.

However, in order to verify that the apparent image and the coded area correspond, sophisticated and expensive material for un-coding is necessary for the personnel in charge of an identity check and the identity verification process is slowed down.

It is also known to produce a fluorescent image on an identification document like in US 2005/0161512. However, under visible light, such a fluorescent image is not visible at all for the personnel in charge of an identity check and it is likely that the check of such a security item is omitted. In addition, the image is surface printed showing therefore the above mentioned drawbacks of surface printed images that are visible under exposure of visible light.

U.S. Pat. No. 8,314,828 in the name of Gemalto S. A. of Mendon, France discloses a method for personalization of an identity card by producing a color image thereon by selectively exposing photon-sensitive layers on the card to change between transparent and opaque thereby revealing opaque colors from the photon-sensitive layer. The content of U.S. Pat. No. 8,314,828 is incorporated by reference to the present application. From the foregoing it will be apparent that there is a need to provide for supplemental personalized security items on identity card that may be checked without complex processing material.

Counterfeiting of documents such as banknotes is becoming now more than ever a serious problem, due to the availability of high-quality and low-priced color photocopiers and desk-top publishing systems. The same is also true for other valuable products such as CDs, DVDs, software packages, medical drugs, etc., that are often marketed in easy to falsify packages.

The present embodiments are concerned with providing a novel security element and authentication means offering enhanced security for cards and travel documents such as credit cards, identity cards, passports; industrial packages or any other valuable articles, thus making them much more difficult to counterfeit.

Various sophisticated means have been introduced in the prior art for counterfeit prevention and for authentication of documents or valuable articles. Some of these means are clearly visible to the naked eye and are intended for the general public, while other means are hidden and only detectable by the competent authorities, or by automatic devices. Some of the already used anti-counterfeit and authentication means include the use of special paper, special inks, watermarks, micro-letters, security threads, holograms, etc. Nevertheless, there is still an urgent need to introduce further security elements, which do not considerably increase the cost of the produced documents or goods.

Moiré effects have already been used in prior art for the authentication of documents. For example, United Kingdom U.S. Pat. No. 1,138,011 (Canadian Bank Note Company) discloses a method which relates to printing on the original document special elements which, when counterfeited by means of halftone reproduction, show a moiré pattern of high contrast. Similar methods are also applied to the prevention of digital photocopying or digital scanning of documents (for example, U.S. Pat. No. 5,018,767, inventor Wicker). In all these cases, the presence of moiré patterns indicates that the document in question is counterfeit. Other prior art methods, on the contrary, take advantage of the intentional generation of a moiré pattern whose existence, and whose precise shape, are used as a means of authenticating the document. One known method in which a moiré effect is used to make visible an image encoded on the document (as described, for example, in the section “Background” of U.S. Pat. No. 5,396,559 (McGrew)) is based on the physical presence of that image on the document as a latent image, using the technique known as “phase modulation”. In this technique, a uniform line grating or a uniform random screen of dots is printed on the document, but within the pre-defined borders of the latent image on the document the same line grating (or respectively, the same random dot-screen) is printed in a different phase, or possibly in a different orientation. For a layman, the latent image thus printed on the document is hard to distinguish from its background; but when a revealing transparency comprising an identical, but unmodulated, line grating (respectively, random dot-screen) is superposed on the document, thereby generating a moiré effect, the latent image pre-designed on the document becomes clearly visible, since within its pre-defined borders the moiré effect appears in a different phase than in the background. However, this previously known method has the major flaw of being simple to simulate, since the form of the latent image is physically present on the document and only filled by a different texture. A second limitation of this technique resides in the fact that there is no enlargement effect: the pattern image revealed by the superposition of the base layer and of the revealing transparency has the same size as the latent image.

In U.S. Pat. No. 5,712,731 (Drinkwater et al.) a moiré based method is disclosed which relies on a periodic 2D array of microlenses. However, this last disclosure has the disadvantage of being limited only to the case where the superposed revealing structure is a microlens array and the periodic structure on the document is a constant 2D dot-screen with identical dot-shapes replicated horizontally and vertically. Thus, in contrast to the present invention, that invention excludes the use of gratings of lines as the revealing layer, both imaged on a transparent support (e.g. film) or as a grating of cylindric microlenses. Furthermore, that invention does not allow to create, as in the present invention, a document with a base layer comprising patterns made of varying shapes, intensities and colors.

Other moiré based methods disclosed by Amidror and Hersch in U.S. Pat. No. 6,249,588 and its continuation-in-part U.S. Pat. No. 5,995,638 rely on the superposition of arrays of screen dots which yields a moiré intensity profile indicating the authenticity of the document. These inventions are based on specially designed 2D periodic structures, such as dot-screens (including variable intensity dot-screens such as those used in real, gray level or color halftoned images), pinhole-screens, or microlens arrays, which generate in their superposition periodic moiré intensity profiles of chosen colors and shapes (typographic characters, digits, the country emblem, etc.) whose size, location and orientation gradually vary as the superposed layers are rotated or shifted on top of each other.

In a third invention, U.S. patent application Ser. No. 09/902,445, Amidror and Hersch disclose new methods improving their previously disclosed methods mentioned above. These new improvements make use of the theory developed in the paper “Fourier-based analysis and synthesis of moirés in the superposition of geometrically transformed periodic structures” by I. Amidror and R. D. Hersch, Journal of the Optical Society of America A, Vol. 15, 1998, pp. 1100-1113 (hereinafter, “[Amidror98]”), and in the book “The Theory of the Moire Phenomenon” by I. Amidror, Kluwer, 2000 (hereinafter, “[Amidror00]”). According to this theory, such invention discloses how it is possible to synthesize aperiodic, geometrically transformed dot screens which in spite of being aperiodic in themselves, still generate, when they are superposed on top of one another, periodic moiré intensity profiles with undistorted elements, just like in the periodic cases disclosed by Hersch and Amidror in their previous U.S. Pat. No. 6,249,588 and its continuation-in-part U.S. Pat. No. 5,995,638. U.S. patent application Ser. No. 09/902,445 further disclosed how cases which do not yield periodic moirés can still be advantageously used for anticounterfeiting and authentication of documents and valuable articles.

In U.S. patent application Ser. No. 10/183,550 “Authentication with build-in encryption by using moiré intensity profiles between random layers”, inventor Amidror discloses how a moiré intensity profile is generated by the superposition of two specially designed random or pseudorandom dot screens. An advantage of that invention relies in its intrinsic encryption system offered by the random number generator used for synthesizing the specially designed random dot screens.

However, the disclosures above made by inventors Hersch and Amidror (U.S. Pat. Nos. 6,249,588, 5,995,638. U.S. patent application Ser. No. 09/902,445) or Amidror (US Appl. Ser. 10/183′550) making use of the moiré intensity profile to authenticate documents have two drawbacks. The first drawback is due to the fact that the revealing layer is made of dot screens, i.e. of a set (2D array) of tiny dots laid out on a 2D surface. The second drawback is due to the fact that the base layer is made of a two-dimensional array of similar dots (dot screen) where each dot has a very limited space within which one or a very small number of tiny shapes such as typographic characters, digits or logos must be placed. This space is limited by the 2D frequency of the dot screen, i.e. by its two period vectors. The higher the 2D frequency, the less space there is for placing the tiny shapes which, when superposed with a 2D circular dot screen as revealing layer, produce as 2D moiré an enlargement of these tiny shapes. Nevertheless, high enough frequencies are needed to ensure a good protection against counterfeiting attempts.

EP 1554700 published on Jan. 3, 2007 by inventors Roger D. Hersch and Sylvain Chosson of Ecole Poytechnique Federale de Lausanne (EPFL) is based on the discovery that a band grating incorporating original shapes superposed with a revealing line grating yields a band moiré comprising moiré shapes which are a linear or possibly non-linear transformation of the original shapes incorporated into the band grating. Since band moiré have a much better light efficiency than moiré intensity profiles relying on dots screens, the techniques in EP1554700 can be advantageously used in all cases where the other disclosures fail to show strong enough moiré patterns. In particular, the base band grating incorporating the original pattern shapes may be printed on a reflective support and the revealing line screen may simply be a film with thin transparent lines. Due to the high light efficiency of the revealing line screen, the strong band moiré patterns representing the transformed original band patterns are clearly revealed. A further advantage of the disclosure in EP1554700 resides in the fact that the produced moiré may comprise a large number of patterns, for example a text sentence (several words) or a paragraph of text.

U.S. Pat. No. 7,194,105 published on Mar. 20, 2007 by inventors Roger D. Hersch and Sylvain Chosson of EPFL disclose embodiments that rely on the moiré patterns generated when superposing a base layer made of base band patterns and a revealing line grating (revealing layer). The produced moiré patterns comprise an enlargement and a transformation of the individual patterns located within the base bands. Base bands and revealing line gratings may be rectilinear or curvilinear. When translating or rotating the revealing line grating on top of the base layer, the produced moiré patterns evolve smoothly, i.e. they may be smoothly shifted, sheared, and possibly be subject to further transformations. Base band patterns may incorporate any combination of shapes, intensities and colors, such as letter, digits, text, symbols, ornaments, logos, country emblems, etc. . . . They therefore offer great possibilities for creating security documents and valuable articles taking advantage of the higher imaging capabilities of original imaging and printing systems, compared with the possibilities of the reproduction systems available to potential counterfeiters. Since the revealing line grating reflects a relatively high percentage of the incident light, the moiré patterns are easily apparent in reflective mode and under normal illumination conditions. They may be used for the authentication of many kinds of documents (banknotes, identity documents, checks, diploma, travel documents, tickets) and valuable articles (optical disks, CDs, DVDs, CD-ROMs, packages for medical drugs, bottles, articles with affixed labels). However, such techniques have not been implemented on Sealys windows within cards.

U.S. Pat. No. 7,305,105 published on Mar. 20, 2007 by inventors Sylvain Chosson and Roger D. Hersch of EPFL disclose embodiments that include a method and system used for creating advanced protection means for secure items (e.g. bank notes, identity documents, certificates, checks, diploma, travel documents, tickets) and valuable products (e. g CD-ROMs, DVD's, prescription drugs, products with affixed labels, watches). Secure items are authenticated by shape level lines. The shape level lines become apparent when superposing a base layer comprising sets of lines and a revealing layer comprising a line grating. One of the two layers is a modified layer which embeds a shape elevation profile generated from an initial, preferably bilevel, motif shape image. By modifying the relative superposition phase of the revealing layer on top of the base layer or vice-versa (e.g. by translation or rotation), shape level lines grow and shrink dynamically. In the case that these shape level lines are present, the secure item is accepted as authentic. Otherwise the item is rejected as suspect. However, such techniques have not been implemented on Sealys windows within cards.

U.S. Pat. No. 7,751,608 published on Jul. 6, 2010 by inventors Roger D. Hersch and Sylvain Chosson of EPFL disclose embodiments that rely on a band moiré image layout model capable of predicting the band moiré image layer layout produced when superposing a base band grating layer of a given layout and revealing line grating layer of a given layout. The base band grating layer, the revealing line grating layer and the resulting band moiré image layout may have a rectilinear or a curvilinear layout. Thanks to the band moiré image layout model, one can choose the layout of two layers selected from the set of base band grating layer, revealing line grating layer and band moiré image layer and obtain the layout of the third layer by computation, i.e. automatically. The presented methods may be used for creating an individualized protection for various categories of documents (banknotes, identity documents, checks, diploma, travel documents, tickets) and valuable products (optical disks, medical drugs, products with affixed labels, watches). However, such techniques have not been implemented on Sealys windows within cards.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### SUMMARY

In some embodiments, a personalized medium includes a core layer having at least a clear window or transparent portion, at least a first diffraction grating on an upper surface or a lower surface of the core layer, and a second diffraction grating on an opposing side of the core layer from the first diffraction grating, where the first and second diffraction gratings create a Moire pattern.

In some embodiments, a personalized medium includes a core layer having at least a clear window or transparent portion, a first diffraction grating on an upper surface of the core layer, and a second diffraction grating on a lower surface of the core layer where the first and second diffraction gratings have at least one of slightly different periods, shifted horizontal and vertical positioning, or shifted rotation positioning to create a Moire pattern.

In some embodiments, the clear window or transparent portion turns opaque upon tampering. In some embodiments, the clear window or transparent portion is a Sealys window. In some embodiments, the transparent portion of the core layer encompasses the entire core layer. In some embodiments, the core layer is an opaque core layer having the clear window.

In some embodiments, the core layer, the first diffraction grating, and the second diffraction grating are all polycarbonate and all laminated together. In some embodiments, the core layer, the first diffraction grating, and the second diffraction grating and additional transparent polycarbonate layers on top of the first diffraction grating and below the second diffraction grating are all laminated together.

In some embodiments, the gratings are not at the top or bottom surfaces. The gratings are then made either from parallel slits or fine pattern lines that block light or from a periodic modulation of the refractive index. In this latter case, the diffraction grating is not only strictly polycarbonate.

In some embodiments, the first diffraction grating and the second diffraction grating are arranged and configured with specific layouts for providing appearing and disappearing images, logos, or text. In some embodiment, the medium further includes an added element placed between the first diffraction grating and the second diffraction grating causing a modification of the Moire pattern.

In some embodiments, the medium further includes an added element placed between the first diffraction grating and the second diffraction grating causing a nullification of the Moire pattern enabling a visualization of static or personalized data.

In some embodiments, the medium further includes an added element in the form of an ultraviolet printed pattern placed between the first diffraction grating and the second diffraction grating causing a nullification of only the Moire pattern when viewed under ultraviolet light at an area for the ultraviolet printed pattern enabling a visualization of static or personalized data within the area.

In some embodiments, the medium further includes an added element in the form of an added printed pattern using ultraviolet inks placed between the first diffraction grating and the second diffraction grating causing a nullification of the Moire pattern when viewed under ultraviolet light at an area for the added printed pattern enabling a visualization of static or personalized data within the area and creating a level 2 static security feature.

In some embodiments, the medium further includes an added element in the form of an ultraviolet printed pattern that has removed portions by ablation via lasering causing the Moire pattern to remain visible at the removed portions when viewed under ultraviolet lighting.

In some embodiments, the medium further includes an added element in the form of an added metallic layer with removed areas removed via laser ablation, where the metallic layer is placed between the first diffraction grating and the second diffraction grating causing the Moire pattern to be visible only at the removed areas to provide a personalized level 1 security feature.

In some embodiments, a personalized medium, includes a core layer having at least a clear window or transparent portion and at least a first diffraction grating on an upper surface or a lower surface of the core layer. At least the first diffraction grating and the core layer (having at least the clear window or transparent portion) are laminated together.

In some embodiments, the personalized medium further includes a second diffraction grating on an opposing side of the core layer from the first diffraction grating, where the first and second diffraction gratings create a Moire pattern. In some embodiments, tilting or movement of the personalized medium causes a rapid movement of the Moire pattern.

In some embodiments, a personalized medium includes an opaque core layer made of polycarbonate having at least a clear window or transparent portion, a first diffraction grating formed at least within the clear window or transparent portion on an upper surface of the opaque core layer, and a second diffraction grating formed at least within the clear window or transparent portion on a lower surface of the core layer. In some embodiments, the first and second diffraction gratings have at least one of slightly different periods, shifted horizontal and vertical positioning, or shifted rotation positioning to create a Moire pattern and where the first diffraction grating, the opaque core layer and the second diffraction grating are laminated together to form the personalized medium.

In some embodiments, the Moire pattern shifts rapidly upon tilting or movement of the personalized medium and provides a strong color variation combined with dark or bright fringe pattern movement.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1 is an exploded perspective view of a prior art identity card that allows some level of personalization of the physical appearance of the card post-issuance;

FIG. 2A illustrates an exploded view of an identity card in accordance with the embodiments;

FIG. 2B illustrates an exploded view of another identity card in accordance with the embodiments;

FIG. 2C illustrates an exploded view of another card in accordance with the embodiments;

FIG. 2D illustrates a top view of an identity card at a perspective when the Moire pattern is not visible in accordance with the embodiments;

FIG. 2E illustrates a top view of the identity card of FIG. 2D at a perspective when the Moire pattern is visible in accordance with the embodiments;

FIG. 2F illustrates a top view of an identity card at a perspective when a Moire pattern is visible and yet hiding text or other patterns in accordance with the embodiments;

FIG. 2G illustrates a top view of the identity card of FIG. 2F at a perspective when a Moire pattern is visible and further disclosing text or other patterns in accordance with the embodiments;

FIG. 2H illustrates a top view of the identity card of FIG. 2G at a perspective and under ultraviolet lighting conditions that cancels the Moire pattern and further discloses text or other patterns in accordance with the embodiments;

FIG. 3A-3C illustrates cross sectional views of three alternative embodiments similar to the identity card shown in FIG. 2 in accordance with the embodiments.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. Also in these instances, well-known structures may be omitted or shown and described in reduced detail to avoid unnecessarily obscuring descriptions of the embodiments.

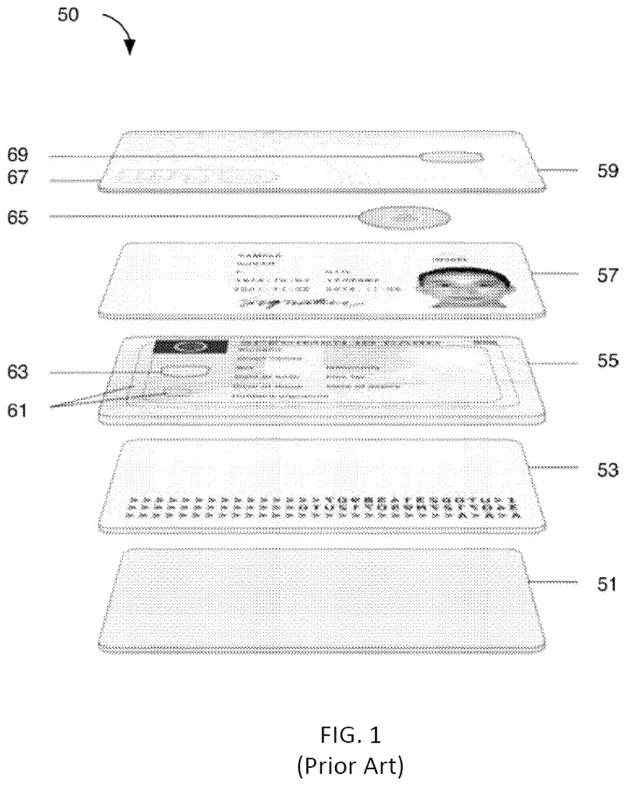

FIG. 1 is an exploded perspective view of a prior art identity card 50 that allows some level of personalization of the physical appearance of the card post-issuance, e.g., by the customer. Such a card 50 may, for example, have the following layers:
a transparent polycarbonate (PC) layer 59
a laser-engravable transparent PC layer 57
an opaque white PC core 55
a laser-engravable transparent PC layer 53
a transparent PC layer 51

As anti-counterfeiting measures, the top PC layer 59 may include some embossing 67 and a changeable laser image/multi laser image (CLI/MLI) 69. To further enhance security the card 50 may include features such as a DOVID 65, i.e., a Diffractive Optical Variable Image Device such as a hologram, kinegram or other secure image, and a Sealys Window 63 (a security feature, provided by Gemalto S. A., Meudon, France, in which a clear window that turns opaque upon tampering is provided in the card). The card 50 may also contain a contactless chip and antenna system 61.

During personalization the laser-engravable transparent layers 57 and 53 may be provided with a gray-scale image and identifying text.

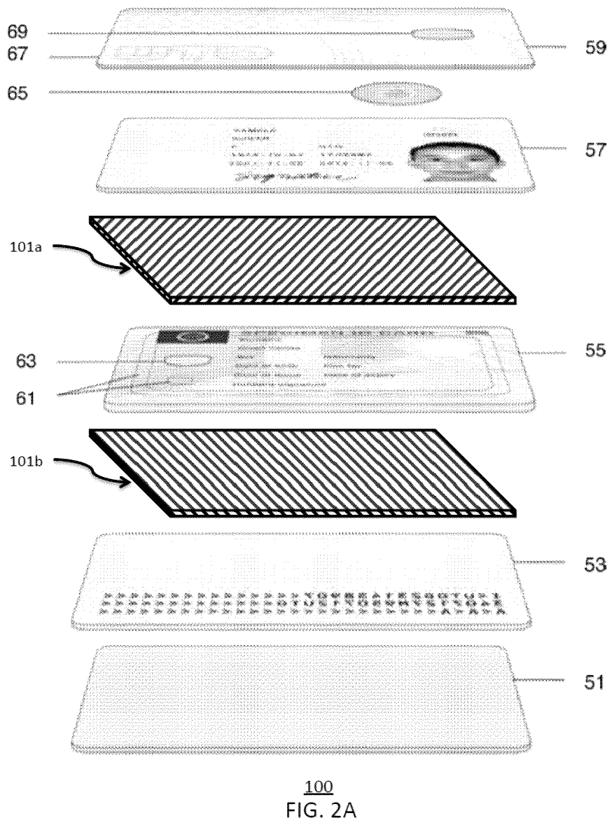

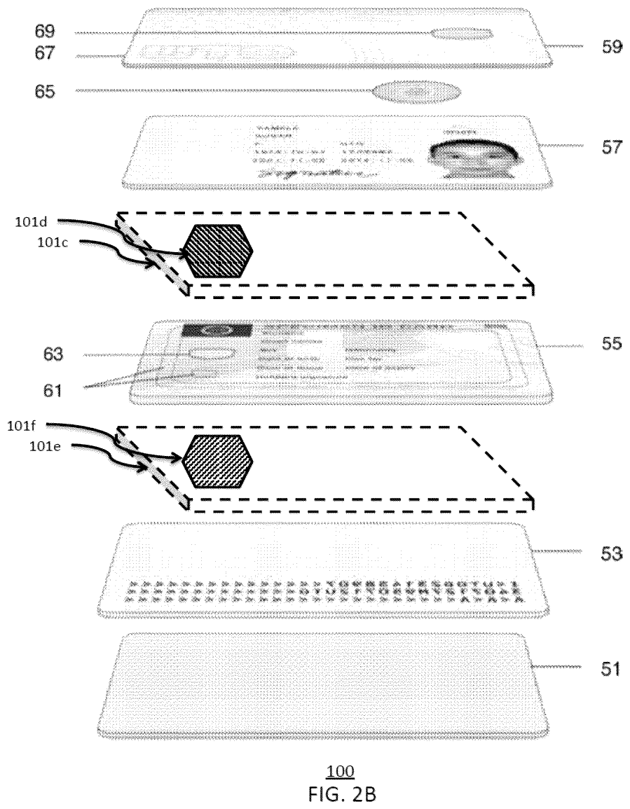

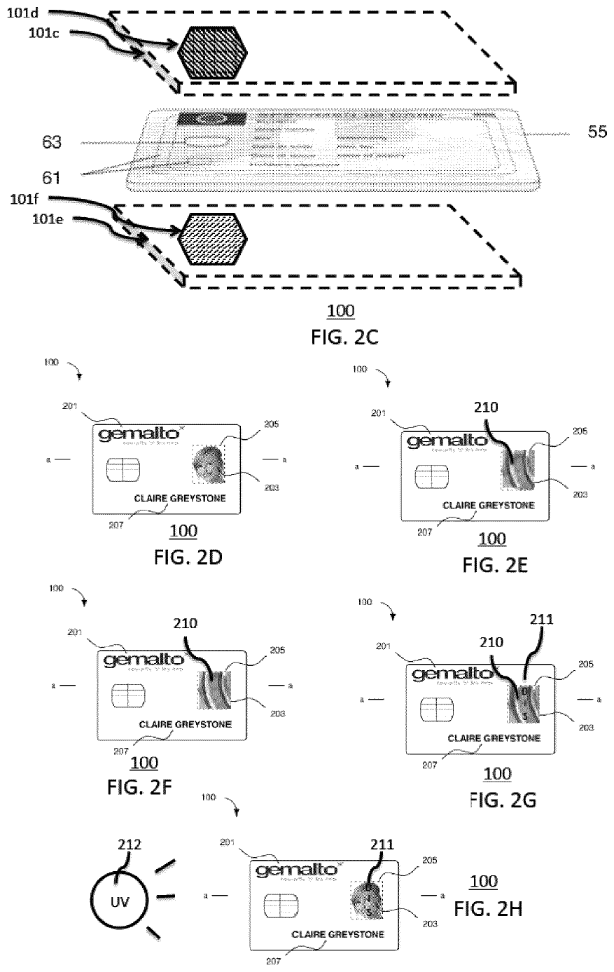

FIG. 2A is an exploded view of a new identity card 100 that includes at least some or all of the elements of the identity card 50 of FIG. 1, but further includes a first diffraction grating 101a having a first pattern on an upper surface of the core layer 55 having the window 63 and yet further includes a second diffraction grating 101b having a second pattern on a lower surface of the core layer 55 that has the window 63.

FIG. 2B is an exploded view of a new identity card 100 that includes at least some or all of the elements of the identity card 50 of FIG. 1, but further includes a first diffraction grating 101d having a first pattern on an upper surface of the core layer 55 having the window 63 and yet further includes a second diffraction grating 101f having a second pattern on a lower surface of the core layer 55 that has the window 63. The gratings 101d and 101f can be applied directly above and below the window 63 by themselves or they can be part of respective translucent substrates (101c and 101e) as shown.

FIG. 2C is an exploded view of a new identity card 100 that includes at least some of the elements of the identity card 50 of FIG. 1 including at least the core 55, but further includes a first diffraction grating 101d having a first pattern on an upper surface of the core 55 having the window 63 and yet further includes a second diffraction grating 101f having a second pattern on a lower surface of the core 55 that has the window 63. The gratings 101d and 101f can be applied directly above and below the window 63 by themselves as in other embodiments or they can be part of respective translucent substrates (101c and 101e) as shown.

FIG. 2D is a top-view of an identity card 100 according to one embodiment of the technology described herein. Briefly, the identity card 100 is provided with an image area 205 that is constructed from several layers of material located between a substrate (e.g., a PC core 55) and a lamination layer. The bottom layer of these image-area layers can be a print-pixel grid which consists of a plurality of specifically arranged areas having distinct colors. The print-pixel grid is covered by a transparent layer and an opaque layer of photon-sensitive materials. The transparent layer may be selectively altered to some level of opaque black and the opaque layer may be selectively altered to transparent. Thus, by selective manipulation of the photon-sensitive layers, any given location of the image area 205 may be made to display a specific color from the print-pixel grid, black (or a darkened shade of the underlying grid sub-sub-pixel), or white. By selectively manipulating the photon-sensitive layers of the addressable locations (as is discussed hereinbelow, the addressable locations are referred to herein as sub-sub-pixels) of the image area, an image may be produced. The structure of the print-pixel grid and the photon-sensitive layers, and the process of manipulating these layers to produce an image are discussed in greater detail herein below. At a certain perspective, as shown in FIG. 2D, a Moire pattern is unseen or remains hidden.

The identity card 100 may have been printed with a company-logo or other graphic. Through a unique process and manufacture described in greater detail herein below, the identity card 100 contains a color image 203, for example, a photograph of the intended end-user, printed in an image area 205. The identity card 100 may further have been personalized with a printed name 207. The printed name 207 may be applied to the card using the same techniques as described-herein for applying an image 203 to the identity card 100. In FIG. 2E, where the card 100 is viewed from a certain perspective, the Moire pattern 210 is revealed.

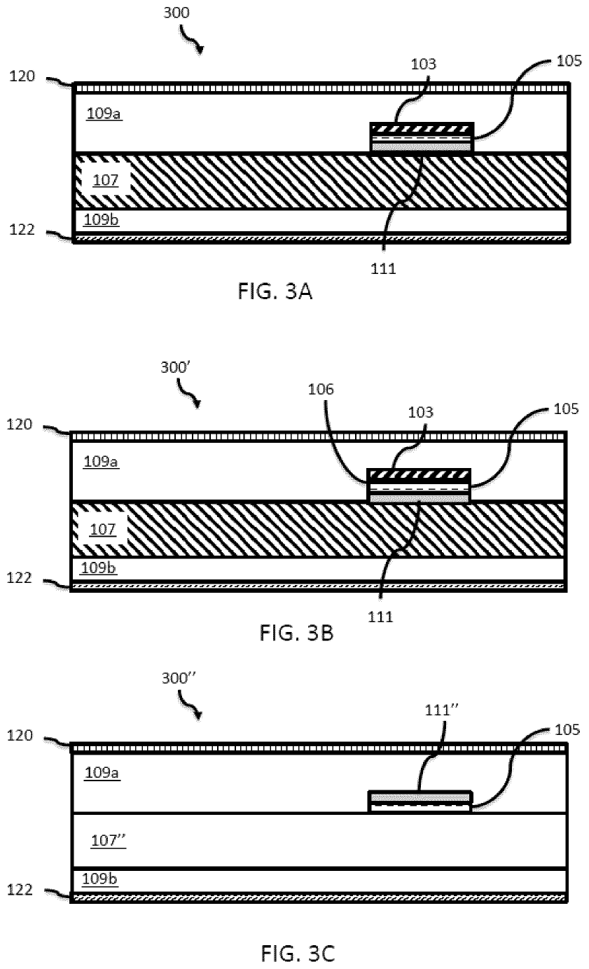

In FIG. 2F, the Moire pattern is still seen, but any print-pixel grid imaging underneath remains hidden under the Moire pattern. In FIG. 2G, when viewed from a certain perspective, the underlying print-pixel grid imaging 211 representing the lettering “DIS” is revealed within the Moire pattern. FIG. 3A is a cross-section of an identity card 300 similar to the cards shown in FIGS. 2A-2G. The identity card 300 consists of a substrate 107. The substrate 107 may be constructed from a plastic material, for example, selected from polycarbonate polyvinyl chloride (PVC), acrylonitrile butadiene styrene (ABS), PVC in combination with ABS, polyethylene terephthalate (PET), PETG, and polycarbonate (PC). As with the prior art identity card 50 of FIG. 1, the identity card 100 may include additional layers, e.g., laser-engravable PC layers 53 and 59 and transparent PC layers 51 and 59.

A print-pixel grid 111 is located on one surface of the substrate 107 (substrate 107 is meant herein to refer to any of the internal layers of the card 100, e.g., similar to the opaque PC layer 55, either transparent PC layer 53 or 57, or internal layers constructed from alternative materials) in an area of the substrate corresponding to the image area 205 (See FIGS. 2D-2G). The print-pixel grid 111, which is described in greater detail herein below in conjunction with, for example, may be printed onto the substrate using conventional offset printing or using any other technique for accurately laying down a colored pattern onto the substrate.

The print-pixel grid 111 is covered by a transparent photon-sensitive layer 105. The transparent photon-sensitive layer 105 is manufactured from a material that converts from being transparent to some level of opaqueness upon being exposed to photons of particular wavelength and intensity. Suitable materials include carbon-doped polycarbonate. Traditionally polycarbonate (PC) ID products have been personalized using laser-engraving technology. This personalization is based on a laser beam heating carbon particles inside specific polycarbonate layers to the extent that the polycarbonate around the particle turns black. While the particles could be materials other than carbon, it is the intrinsic property of polycarbonate that creates the desired contrast and number of gray levels to allow creation of a photographic image. The gray tone is controlled by the laser power and speed of scanning across the image area 205. Thus, a carbon-doped transparent PC layer may be selectively altered into an opaque layer along the darkness scale by exposing select location with a Nd-YAG laser or Fiber Laser. An Nd-YAG laser emits light at a wavelength of 1064 nanometers in the infrared light spectrum. Other Nd-YAG laser wavelengths available include 940, 1120, 1320, and 1440 nanometers. These wavelengths are all suitable for turning a transparent PC layer opaque black or partially opaque with an intensity in the range of 10 to 50 watts. In a typical application, the Nd-YAG laser is scanned (in the manner discussed in greater detail below) over the image area for a duration of approximately 4 seconds exposing specific locations as required. Fiber lasers that are suitable for turning the transparent PC layer opaque or partially opaque operate in wavelengths in the range of 600 to 2100 nanometers. While some specific lasers and wavelengths are discussed herein above, any alternative photon source, e.g., a UV laser, that converts a location on a transparent PC layer opaque may be employed in lieu thereof. Certain wavelengths may interplay better with the Moire patterns contemplated herein than others.

The transparent photon-sensitive layer 105 can be covered with an opaque layer 103 that may be altered into a transparent layer by exposure to photons in a particular wavelength and intensity. Suitable materials for the opaque-to-transparent photon-sensitive layer include a white bleachable ink that may be laid down on top of the transparent-to-opaque layer 105 through thermal transfer or die sublimation, for example. Examples, include SICURA CARD 110 N WA (71-010159-3-1180) (ANCIEN CODE 033250) from Siegwerk Druckfarben A G, Sieburg, Germany, Dye Diffusion Thermal Transfer (D2T2) inks available from Datacard Group of Minnetonka, Minn., USA or Dai Nippon Printing Co., Tokyo, Japan. Such materials may be altered selectively by exposing particular locations by a UV laser at a wavelength of, for example, 355 nanometers or 532 nanometers with an intensity in the range of 10 to 50 watts for a few milliseconds per addressable location (sub-sub-pixel). To alter the sub-sub-pixels in the opaque-to-transparent layer 103 the laser is continuously scanned over the image area exposing those sub-sub-pixels that are to be altered from opaque white to transparent in the opaque-to-transparent layer 103 by ink bleaching or evaporation. In an alternative embodiment, the same UV laser wavelength that removes the ink of the opaque-to-transparent layer 103 may also be used to alter the carbon-doped transparent-to-opaque layer 105 below the removed sub-sub-pixels of the opaque-to-transparent layer 103 when there is residual power available from the UV laser. All the aforementioned layers can be sandwiched between lamination layers 109a and 109b. Diffraction gratings 120 and 122 can either be placed on either side of the lamination layers 109a and 109b (as shown) or on either side of additional lamination layers (not shown).

In an alternative embodiment the opaque-to-transparent layer 103 is a photon-sensitive layer that is amenable to a dry photographic process that requires no chemical picture treatment. One example is spiropyran photochrom with titanium oxide (similar to the material used to produce with PVC). This process is based on the photochemical behavior of colored complexes between spiropyrans and metal ions.

In an alternative embodiment 300′, illustrated in FIG. 3B, the opaque-to-transparent layer 103 is augmented with a doped organic semiconductor layer 106. The doped organic semiconductor layer 106 is useful as an amplifier to improve the speed by which the opaque-to-transparent layer 103 transforms from opaque to transparent. Example materials for the doped organic semiconductor layer 106 include polyvinyl carbazol and polythiophenes. A polyvinyl carabazol layer 106 may be laid down by evaporation of 2.5 grams of polyvinyl carabazol in 50 cubic-centimeters of dichloromethane. The semiconductor layer 106 is preferably doped to match the energy levels required for a photochromic effect in the opaque-to-transparent layer 103.

The photochromic effect of spiropyran-based opaque-to-transparent layer 103 may be achieved by exposure to visible or ultraviolet light. The preferred intensity is in the range of 50 to 200 watts at a distance of 30 to 300 millimeters for a duration of 10 to 300 seconds.

The principle of preparation of emulsions for a dry color printing process has been patented by Prof. Robillard (US Pat. Appl. 2004259975). The results of feasibility investigation is described in a J. Robillard et al, Optical Materials, 2003, vol. 24, pp 491-495. The process involves photographic emulsions that require exclusively light of the UV or visible range for producing and fixing images. The emulsions include colored photochromic dyes and a system for amplification and exhibit photosensitivity comparable to those of the known silver-containing conventional materials. In general, this process is applicable for any kind of supports (paper, tissues, polymeric films).

Finally, the identity card 100 is covered as noted above with the upper lamination layer 109a and a lower lamination layer 109b where the diffraction gratings can reside just outside the lamination layers 109a and b or within additional lamination layers (not shown) as needed. The lamination layers 109 provide security in that they protect the image 203 produced in the image area 205 from physical manipulation. The upper lamination layer 109a should be transparent to the photon wavelengths used for altering the transparent-to-opaque layer 105 and the opaque-to-transparent layer 103. Furthermore, the lamination temperature should be low enough as to not alter the transparent-to-opaque layer 105 or opaque-to-transparent layer 103, for example, in the range of 125 to 180 degrees Celsius. Suitable materials include PVC, PVC-ABS, PET, PETG, and PC.

FIG. 3C is a cross-section view of yet another alternative embodiment for an identity card 300″ that may be personalized with a color image produced on the card during the personalization phase. A photon-sensitive print-pixel grid 111″ is located above a carbon-doped PC layer 105 which in turn is located above a white opaque PC layer 107″. The print-pixel grid 111″ in this case consists of multiple sub-sub-pixels that may be selectively removed by exposure to photons of appropriate wavelength and intensity. The image area 205 may be customized with a color image 203 by selectively removing colored sub-sub-pixels from the photon-sensitive pixel-grid 111″ and by subjecting the carbon-doped PC layer 105 selectively to photon-energy that alters select portions thereof from transparent to black. As with the other embodiments, the identity card 300″ further includes diffraction gratings 120 and 122 that can either be placed on either side of the lamination layers 109a and 109b (as shown) or on either side of additional lamination layers (not shown).

While it is desirable to prepare the entire card during the manufacturing phase of the card life-cycle, in some embodiments applying the technology described herein that is not practical because the upper lamination layer 109a could prevent evaporation of dyes from the opaque-to-transparent layer 103 or 111″. Therefore, if the alteration of one of the photon-sensitive layers requires evaporation or some other form of material removal in the process of transforming from one state to another, e.g., from opaque to transparent, the upper lamination layer 109a may be added during the personalization phase, for example, after the image area 205 has been personalized as described herein. Such lamination may be performed using DNP CL-500D lamination media from Dai Nippon Printing Co., Tokyo, Japan or other suitable lamination technology. In some embodiments as illustrated in FIGS. 2A and 2B, a personalized medium 100 includes a core layer 55 having at least a clear window or transparent portion 63, a first diffraction grating 101a on an upper surface of the core layer, and a second diffraction grating 101b on a lower surface of the core layer where the first and second diffraction gratings have at least one of slightly different periods, shifted horizontal and vertical positioning, or shifted rotation positioning to create a Moire pattern 210 (see FIGS. 2E-2G).

In some embodiments, the clear window or transparent portion 63 turns opaque upon tampering. In some embodiments, the clear window or transparent portion 63 is a Sealys window. In some embodiments, the transparent portion of the core layer 55 encompasses the entire core layer. In other words, in some embodiments, the entire core layer 55 is a clear window or transparent portion. In some embodiments, the core layer is an opaque core layer having the clear window 63.

In some embodiments and referring FIGS. 2A, 2B, 3A-C, the core layer 55, the first diffraction grating 101a or 120, and the second diffraction grating 101b or 122 are all polycarbonate and all laminated together. In some embodiments, the core layer 55, the first diffraction grating, and the second diffraction grating and additional transparent polycarbonate layers on top of the first diffraction grating and below the second diffraction grating are all laminated together. Identity cards can have multiple lamination stages depending on the security features present.

In some embodiments, the first diffraction grating and the second diffraction grating are arranged and configured with specific layouts for providing appearing and disappearing images, logos, or text. In some embodiments as shown in FIGS. 3A-3C, the medium 300, 300′ or 300″ further includes at least an added element placed (111, 105, 103 and/or 106) between the first diffraction grating 120 and the second diffraction grating 122 causing a modification (211) of the Moire pattern 210 (see FIG. 2G).

In some embodiments, the medium further includes an added element placed between the first diffraction grating and the second diffraction grating causing a nullification of the Moire pattern enabling a visualization of static or personalized data.

In some embodiments, the medium further includes an added element in the form of an ultraviolet printed pattern placed between the first diffraction grating and the second diffraction grating causing a nullification of only the Moire pattern when viewed under ultraviolet light at an area for the ultraviolet printed pattern enabling a visualization of static or personalized data within the area.

In some embodiments as shown in FIGS. 2G, 2H and 3A-3C, the medium 100 further includes an added element in the form of an added printed pattern using ultraviolet inks placed between the first diffraction grating and the second diffraction grating causing a nullification (as shown in FIG. 2H) of the Moire pattern 210 when viewed under ultraviolet light 212 at an area for the added printed pattern enabling a visualization of static or personalized data 211 within the area and creating a level 2 static security feature.

In some embodiments, the medium further includes an added element in the form of an ultraviolet printed pattern that has removed portions by ablation via lasering causing the Moire pattern to remain visible at the removed portions when viewed under ultraviolet lighting.

In some embodiments, the medium further includes an added element in the form of an added metallic layer with removed areas removed via laser ablation, where the metallic layer is placed between the first diffraction grating and the second diffraction grating causing the Moire pattern to be visible only at the removed areas to provide a personalized level 1 security feature.

In some embodiments, a personalized medium 100, includes a core layer 55 having at least a clear window or transparent portion 63 and at least a first diffraction grating (101a or 101b or 101d or 101f) on an upper surface or a lower surface of the core layer 55. At least the first diffraction grating and the core layer (having at least the clear window or transparent portion) are laminated together.

In some embodiments, the personalized medium further includes a second diffraction grating (101b or 101f) on an opposing side of the core layer from the first diffraction grating (101a or 101d), where the first and second diffraction gratings create a Moire pattern 210. In some embodiments, tilting or movement of the personalized medium causes a rapid movement of the Moire pattern.

In some embodiments, a personalized medium 100 includes an opaque core 55 layer made of polycarbonate having at least a clear window or transparent portion 63, a first diffraction grating 101a formed at least within the clear window or transparent portion 63 on an upper surface of the opaque core layer, and a second diffraction grating 101b formed at least within the clear window or transparent portion on a lower surface of the core layer. In some embodiments, the first and second diffraction gratings have at least one of slightly different periods, shifted horizontal and vertical positioning, or shifted rotation positioning to create a Moire pattern 210 and where the first diffraction grating, the opaque core layer and the second diffraction grating are laminated together to form the personalized medium.

In some embodiments, the Moire pattern shifts rapidly upon tilting or movement of the personalized medium and provides a strong color variation combined with dark or bright fringe pattern movement.

In the absence of any specific clarification related to its express use in a particular context, where the terms “substantial” or “about” or “usually” in any grammatical form are used as modifiers in the present disclosure and any appended claims (e.g., to modify a structure, a dimension, a measurement, or some other characteristic) , it is understood that the characteristic may vary by up to 30 percent.

The terms “include” and “comprise” as well as derivatives thereof, in all of their syntactic contexts, are to be construed without limitation in an open, inclusive sense, (e.g., “including, but not limited to”). The term “or,” is inclusive, meaning and/or. The phrases “associated with” and “associated therewith,” as well as derivatives thereof, can be understood as meaning to include, be included within, interconnect with, contain, be contained within, connect to or with, couple to or with, be communicable with, cooperate with, interleave, juxtapose, be proximate to, be bound to or with, have, have a property of, or the like.

Unless the context requires otherwise, throughout the specification and claims which follow, the word “comprise” and variations thereof, such as, “comprises” and “comprising,” are to be construed in an open, inclusive sense, e.g., “including, but not limited to.”

Reference throughout this specification to “one embodiment” or “an embodiment” or “some embodiments” and variations thereof mean that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content and context clearly dictates otherwise. It should also be noted that the conjunctive terms, “and” and “or” are generally employed in the broadest sense to include “and/or” unless the content and context clearly dictates inclusivity or exclusivity as the case may be. In addition, the composition of “and” and “or” when recited herein as “and/or” is intended to encompass an embodiment that includes all of the associated items or ideas and one or more other alternative embodiments that include fewer than all of the associated items or idea.

In the present disclosure, conjunctive lists make use of a comma, which may be known as an Oxford comma, a Harvard comma, a serial comma, or another like term. Such lists are intended to connect words, clauses or sentences such that the thing following the comma is also included in the list.

As the context may require in this disclosure, except as the context may dictate otherwise, the singular shall mean the plural and vice versa. All pronouns shall mean and include the person, entity, firm or corporation to which they relate. Also, the masculine shall mean the feminine and vice versa.

When so arranged as described herein, each computing device or processor may be transformed from a generic and unspecific computing device or processor to a combination device comprising hardware and software configured for a specific and particular purpose providing more than conventional functions and solving a particular technical problem with a particular technical solution. When so arranged as described herein, to the extent that any of the inventive concepts described herein are found by a body of competent adjudication to be subsumed in an abstract idea, the ordered combination of elements and limitations are expressly presented to provide a requisite inventive concept by transforming the abstract idea into a tangible and concrete practical application of that abstract idea.

The headings and Abstract of the Disclosure provided herein are for convenience only and do not limit or interpret the scope or meaning of the embodiments. The various embodiments described above can be combined to provide further embodiments. Aspects of the embodiments can be modified, if necessary to employ concepts of the various patents, application and publications to provide further embodiments. What is claimed, is:

1. A personalized medium, comprising:
a core layer having at least a clear window or transparent portion;
at least a first diffraction grating on an upper surface or a lower surface of the core layer; and
a second diffraction grating on an opposing side of the core layer from the first diffraction grating;
wherein the first and second diffraction gratings create a Moire pattern

2. The personalized medium according to claim 1, wherein the first diffraction grating is on an upper surface of the core layer and the second diffraction grating is on a lower surface of the core layer, and
wherein the first and second diffraction gratings have at least one of slightly different periods, shifted horizontal and vertical positioning, or shifted rotation positioning to create the Moire pattern.

3. The personalized medium of claim 1, wherein the core layer, the first diffraction grating, and the second diffraction grating are all polycarbonate and all laminated together.

4. The personalized medium of claim 1, wherein the core layer, the first diffraction grating, and the second diffraction grating and additional transparent polycarbonate layers on top of the first diffraction grating and below the second diffraction grating are all laminated together.

5. The personalized medium of claim 1, wherein the first diffraction grating and the second diffraction grating are arranged and configured with specific layouts for providing appearing and disappearing images, logos, or text.

6. The personalized medium of claim 1, wherein the medium further comprises an added element placed between the first diffraction grating and the second diffraction grating causing a modification of the Moire pattern.

7. The personalized medium of claim 1, wherein the medium further comprises an added element placed between the first diffraction grating and the second diffraction grating causing a nullification of the Moire pattern enabling a visualization of static or personalized data.

8. The personalized medium of claim 1, wherein the medium further comprises an added element in the form of an ultraviolet printed pattern placed between the first diffraction grating and the second diffraction grating causing a nullification of only the Moire pattern when viewed under ultraviolet light at an area for the ultraviolet printed pattern enabling a visualization of static or personalized data within the area.

9. The personalized medium claim 1, wherein the medium further comprises an added element in the form of an added printed pattern using ultraviolet inks placed between the first diffraction grating and the second diffraction grating causing a nullification of the Moire pattern when viewed under ultraviolet light at an area for the added printed pattern enabling a visualization of static or personalized data within the area and creating a level 2 static security feature.

10. The personalized medium of claim 1, wherein the medium further comprises an added element in the form of an ultraviolet printed pattern that has removed portions by ablation via lasering causing the Moire pattern to remain visible at the removed portions when viewed under ultraviolet lighting.

11. The personalized medium of claim 1, wherein the medium further comprises an added element in the form of an added metallic layer with removed areas removed via laser ablation, where the metallic layer is placed between the first diffraction grating and the second diffraction grating causing the Moire pattern to be visible only at the removed areas to provide a personalized level 1 security feature.

12. The personalized medium of claim 1, wherein the transparent portion of the core layer encompasses the entire core layer.

13. The personalized medium of claim 1, wherein the core layer is an opaque core layer having the clear window.

14. The personalized medium according to claim 1, wherein the first diffraction grating and the core layer having at least the clear window or transparent portion are laminated together.

15. The personalized medium of claim 14, wherein tilting or movement of the personalized medium causes a rapid movement of the Moire pattern.

16. The personalized medium according to claim 1, wherein the core layer is an opaque core layer made of polycarbonate,
wherein the first diffraction grating is formed at least within the clear window or transparent portion on an upper surface of the opaque core layer and the second diffraction grating is formed at least within the clear window or transparent portion on a lower surface of the opaque core layer;
wherein the first and second diffraction gratings have at least one of slightly different periods, shifted horizontal and vertical positioning, or shifted rotation positioning to create the Moire pattern; and
wherein the first diffraction grating, the opaque core layer and the second diffraction grating are laminated together to form the personalized medium.

17. The personalized medium of claim 16, wherein the Moire pattern shifts rapidly upon tilting or movement and provides a strong color variation combined with dark or bright fringe pattern movement.
